(19) United States
(12) Patent Application Publication
(10) Pub. No.: US 2026/0154312 A1
(43) Pub. Date: Jun. 4, 2026

(54) INFORMATION PROCESSING SYSTEM

(71) Applicant: TOYOTA JIDOSHA KABUSHIKI KAISHA, Toyota-shi (JP)

(72) Inventor: Tetsuya HASHIMOTO, Tokyo (JP)

(73) Assignee: TOYOTA JIDOSHA KABUSHIKI KAISHA, Toyota-shi (JP)

(21) Appl. No.: 19/297,170

(22) Filed: Aug. 12, 2025

(30) Foreign Application Priority Data
Dec. 2, 2024 (JP) 2024-209618

(51) Int. Cl. G06F 16/334; G06N 5/04; H04L 51/02

(52) U.S. Cl. CPC G06F 16/3347; G06N 5/04; H04L 51/02

(57) ABSTRACT

An information processing system includes: a calculator configured to calculate the distance in a feature space between a first feature vector corresponding to first text data registered in a database and a second feature vector corresponding to second text data registered in the database; a determiner configured to determine whether the calculated distance is smaller than a first threshold; and a controller configured to delete one of the first text data and the second text data when the calculated distance is smaller than the first threshold.

### CROSS-REFERENCE TO RELATED APPLICATION

This application claims priority to Japanese Patent Application No. 2024-209618 filed on Dec. 2, 2024. The disclosure of the above-identified application, including the specification, drawings, and claims, is incorporated by reference herein in its entirety.

### BACKGROUND

### 1. Technical Field

The present disclosure relates to the technical field of information processing systems.

### 2. Description of Related Art

As an example of this type of system, a system has been proposed in which a language model generates query data based on documents, and pairs of the documents and the query data are used to train a retrieval model for a dialogue bot (see Japanese Unexamined Patent Application Publication No. 2023-076413 (JP 2023-076413 A)).

### SUMMARY

As a dialogue bot, a large language model (LLM) is combined with a search over a specific information source (hereinafter also referred to as “knowledge base” as appropriate). A chatbot using a mechanism (retrieval-augmented generation (RAG)) that provides a large language model with a proprietary information source has thus been proposed. The knowledge base includes a plurality of pieces of data (e.g., documents). For example, the knowledge base may include one piece of data and another piece of data in which part of the one piece of data item has been updated. For example, the knowledge base may include a plurality of pieces of data having the same or nearly the same content. In such cases, the search accuracy of the knowledge base may deteriorate. The large language model refers to a language model constructed using extremely large datasets and deep learning techniques.

The present disclosure has been made in view of the above issue, and an object thereof is to provide an information processing system that can improve the search accuracy of a knowledge base.

An information processing system according to an aspect of the present disclosure includes:
a calculator configured to calculate the distance in a feature space between a first feature vector corresponding to first text data registered in a database and a second feature vector corresponding to second text data registered in the database;
a determiner configured to determine whether the calculated distance is smaller than a first threshold; and
a controller configured to delete one of the first text data and the second text data when the calculated distance is smaller than the first threshold.

An information processing system according to another aspect of the present disclosure includes:
a calculator configured to calculate the distance in a feature space between a first feature vector corresponding to first text data and a second feature vector corresponding to second text data registered in a database;
a determiner configured to determine whether the calculated distance is smaller than a first threshold; and
a controller configured to either (i) maintain registration of the second text data without registering the first text data in the database or (ii) register the first text data in the database and delete the second text data, when the calculated distance is smaller than the first threshold.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the configuration of an information processing system according to an embodiment;

FIG. 2 is a block diagram showing an example of the configuration of a computing device according to the embodiment;

FIG. 3 is a flowchart illustrating the operation of an information processing system according to a first embodiment; and

FIG. 4 is a flowchart illustrating the operation of an information processing system according to a second embodiment.

### DETAILED DESCRIPTION OF EMBODIMENTS

### First Embodiment

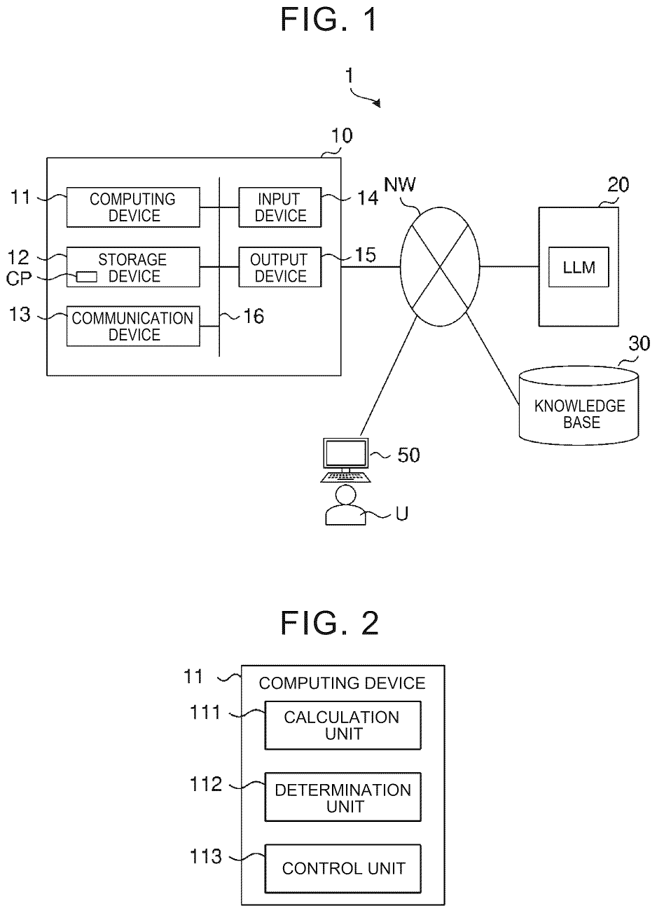

A first embodiment of an information processing system will be described with reference to FIGS. 1 to 3. In FIG. 1, an information processing system 1 includes an information processing device 10, a server 20, and a knowledge base 30. The information processing device 10, the server 20, and the knowledge base 30 are configured to communicate with each other via a network NW. The server 20 is a server for operating a large language model (LLM). Accordingly, the server 20 may be referred to as “LLM server.” The server 20 may be a cloud server.

### Chatbot

The server 20 and the knowledge base 30 may provide a chatbot service using RAG. For example, a user U may use the chatbot service via a terminal device 50. In this case, the user U may operate the terminal device 50 to launch an application for using the chatbot service. The user U may input a question sentence into an input field of a chat application by operating the terminal device 50. The “question sentence” is not limited to an interrogative sentence. For example, the “question sentence” may include sentences in the form of a request, instruction, or command such as “Tell me about . . . ” or “Answer about . . . ” Accordingly, the term “question sentence” refers to a concept that includes not only interrogative sentences but also sentences containing expressions such as requests, instructions, or commands. That is, the “question sentence” may refer to a sentence that seeks a response from the other party.

The terminal device 50 may perform a search of the knowledge base 30 based on the input question sentence. The terminal device 50 may transmit, to the server 20, first information that includes the input question sentence and text data as a search result of the knowledge base 30. The server 20 may input the question sentence and the text data that are included in the first information to the large language model as a prompt. The server 20 may obtain an answer to the question sentence output from the large language model. The server 20 may transmit second information indicating the answer to the terminal device 50. The terminal device 50 that receives the second information may display the answer indicated by the second information on a screen associated with the chat application. The terminal device 50 may be a personal computer, a tablet terminal, or a smartphone.

### Information Processing Device 10

In FIG. 1, the information processing device 10 includes a computing device 11, a storage device 12, a communication device 13, an input device 14, and an output device 15. The computing device 11, the storage device 12, the communication device 13, the input device 14, and the output device 15 are connected via a data bus 16. The information processing device 10 may be a personal computer, a tablet terminal, or a smartphone.

The computing device 11 may include a processor. The computing device 11 may include a single processor or a plurality of processors. In other words, the computing device 11 may include one or more processors. The processor may be a multi-core processor. When the computing device 11 includes a single processor that is a multi-core processor, the computing device 11 may be regarded as logically including a plurality of processors.

The processor may be, for example, at least one of a central processing unit (CPU), a graphics processing unit (GPU), a field programmable gate array (FPGA), and a tensor processing unit (TPU).

The storage device 12 may be, for example, at least one of a random access memory (RAM), a read-only memory (ROM), a hard disk drive, a magneto-optical disk drive, a solid state drive (SSD), and an optical disk array. That is, the storage device 12 may be implemented using a single device or a plurality of devices.

The communication device 13 may be capable of communicating with a device external to the information processing device 10. The communication device 13 may perform wired communication or wireless communication.

The input device 14 is a device capable of receiving input of information into the information processing device 10 from outside. The input device 14 may include an operation device operable by a user of the information processing device 10 (e.g., a keyboard, a mouse, a touch panel, etc.). The input device 14 may include a recording medium reader capable of reading information recorded on a recording medium (such as a Universal Serial Bus (USB) memory) that is attachable to and detachable from the information processing device 10. When information is input to the information processing device 10 via the communication device 13 (in other words, when the information processing device 10 acquires information via the communication device 13), the communication device 13 may serve as an input device.

The output device 15 is a device capable of outputting information to the outside of the information processing device 10. The output device 15 may include a display device capable of outputting visual information such as text or images as the output information. The output device 15 may include a speaker capable of outputting auditory information such as sound as the output information. The output device 15 may include a vibration motor capable of outputting tactile information such as vibration as the output information. The output device 15 may include a printer. The output device 15 may be capable of outputting information to a recording medium (such as a USB memory) that is attachable to and detachable from the information processing device 10. When the information processing device 10 outputs information via the communication device 13, the communication device 13 may serve as an output device.

The storage device 12 is capable of storing desired data. The storage device 12 may store a computer program CP that is executed by the computing device 11. When the computing device 11 is executing the computer program CP, the storage device 12 may temporarily store data temporarily used by the computing device 11.

The computer program CP may be recorded on a computer-readable and non-transitory recording medium. In this case, the computer program CP may be stored in the storage device 12 by reading the recording medium using a recording medium reader (not shown) included in the information processing device 10. At least one of an optical disk, a magnetic medium, a magneto-optical disk, a semiconductor memory, and any other medium capable of storing programs may be used as the recording medium. The computer program CP may be acquired from a device (not shown) external to the information processing device 10 via the communication device 13. In other words, the computer program CP may be downloaded from an external device to the storage device 12 of the information processing device 10.

The computing device 11 (e.g., a processor), together with the storage device 12 storing the computer program CP (in other words, together with the storage device 12 and the computer program CP stored in the storage device 12), may execute processing to be performed by the information processing device 10. For example, logical functional blocks for executing the processing to be performed by the information processing device 10 may be implemented within the computing device 11 (e.g., within the processor) by the computing device 11 executing the computer program CP.

### Knowledge Base 30

A plurality of pieces of text data may be registered in the knowledge base 30. The text data may be data obtained by dividing text included in a single document. Such data may be referred to as “chunk.” Examples of a method for dividing text included in a single document include a method in which the text is divided by a certain length (i.e., a fixed length), a method in which the text is divided by sentence based on sentence delimiters, and a method in which the text is divided based on a structure such as Markdown. Each of the pieces of text data may be registered in a vectorized form in the knowledge base 30. In other words, the knowledge base 30 may be a vector database or a vector store. In addition to text data, image data may be registered in the knowledge base 30.

The following findings have been obtained based on the inventors' research. New text data may be registered in the knowledge base 30 at any time. On the other hand, there is a possibility that a plurality of pieces of text data having the same or nearly the same content may be registered in the knowledge base 30, or that both pre-update and post-update versions of text data may be registered in the knowledge base 30. In addition, there is a possibility that two or more pieces of text data with overlapping content may be retrieved or both pre-update and post-update versions of text data may be retrieved during a search of the knowledge base 30. As a result, the search accuracy of the knowledge base 30 may deteriorate. In other words, in the chatbot service described above, the response accuracy of the large language model may deteriorate.

Accordingly, the information processing device 10 according to the present embodiment manages a plurality of pieces of text data registered in the knowledge base 30. As shown in FIG. 2, the computing device 11 of the information processing device 10 includes a calculation unit 111, a determination unit 112, and a control unit 113 in order to manage the text data. The calculation unit 111, the determination unit 112, and the control unit 113 may be implemented as the logical functional blocks described above. However, at least one of the calculation unit 111, the determination unit 112, and the control unit 113 may be implemented as a physical processing circuit. Alternatively, at least one of the calculation unit 111, the determination unit 112, and the control unit 113 may be implemented as a combination of a logical functional block and a physical processing circuit.

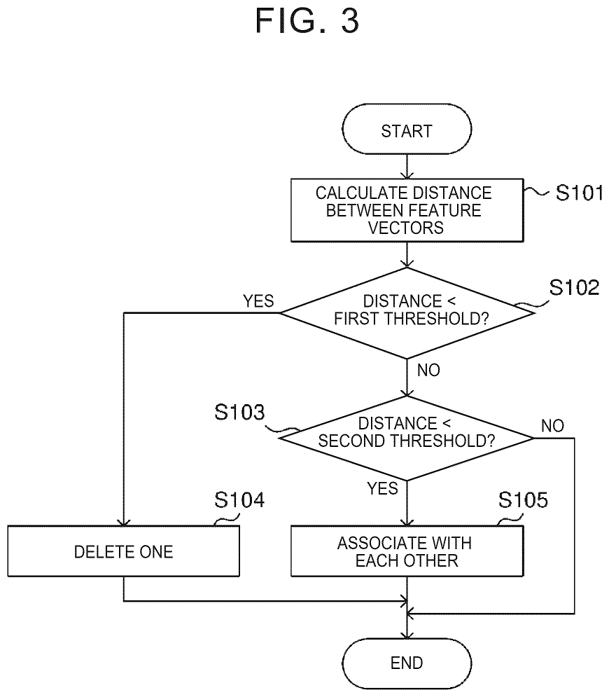

The operation of the information processing device 10 will now be described with reference to the flowchart of FIG. 3. In FIG. 3, the calculation unit 111 of the information processing device 10 selects first text data and second text data that are registered in the knowledge base 30. The calculation unit 111 calculates the distance in a feature space between a first feature vector corresponding to the first text data and a second feature vector corresponding to the second text data (S101). The distance calculated in S101 may be a Euclidean distance. However, the distance may alternatively be a cosine distance (in other words, cosine similarity).

The determination unit 112 of the information processing device 10 determines whether the distance calculated in S101 is smaller than a first threshold (S102) When it is determined in S102 that the distance is smaller than the first threshold (S102: Yes), the control unit 113 of the information processing device 10 deletes one of the first text data and the second text data from the knowledge base 30 (S104).

For example, the control unit 113 may delete one of the first text data and the second text data from the knowledge base 30 based on either or both of update date and time and version information. In this case, the control unit 113 may delete either the first text data or the second text data, whichever has the older update date and time. Alternatively, the control unit 113 may delete either the first text data or the second text data, whichever has an older version as indicated by the version information.

When it is determined in S102 that the distance is greater than the first threshold (S102: No), the determination unit 112 determines whether the distance is smaller than a second threshold (S103). The second threshold is greater than the first threshold. When it is determined in S103 that the distance is smaller than the second threshold (that is, first threshold<distance<second threshold) (S103: Yes), the control unit 113 associates the first text data with the second text data (S105).

When it is determined in S103 that the distance is greater than the second threshold (S103: No), the control unit 113 maintains the registration of both the first text data and the second text data.

The “first threshold” is a value used to determine whether to delete one of the first text data and the second text data. The “second threshold” is a value used to determine whether to associate the first text data with the second text data. The first and second thresholds may be predetermined fixed values, or may be variable values depending on certain parameters. The first and second thresholds may be set based on the relationship between the degree of content overlap between the two pieces of text data and the distance between the two feature vectors corresponding to the two pieces of text data. When the distance is equal to the first threshold in S102, it may be treated as either of the cases. Similarly, when the distance is equal to the second threshold in S103, it may be treated as either of the cases.

### Technical Effects

The information processing system 1 according to the first embodiment can delete redundantly registered text data etc. from among a plurality of pieces of text data registered in the knowledge base 30. The information processing system 1 can therefore reduce the possibility that redundantly registered text data may remain registered or that both pre-update and post-update versions of text data may remain registered. Accordingly, the information processing system 1 can improve the search accuracy of the knowledge base 30. In addition, the storage cost associated with the knowledge base 30 can be reduced.

In the information processing system 1 according to the first embodiment, when the distance between the first feature vector and the second feature vector is greater than the first threshold and smaller than the second threshold, the first text data and the second text data are associated with each other. In a search of the knowledge base 30, the text data associated with each other may be treated as a group of text data.

### Second Embodiment

A second embodiment of the information processing system will be described with reference to FIGS. 1, 2, and 4. The second embodiment is the same as the first embodiment except that part of the operation of the information processing device 10 is different. Accordingly, description that overlaps with the first embodiment will be omitted as appropriate.

When new text data is to be registered in the knowledge base 30, the information processing device 10 according to the second embodiment determines whether to register the text data in the knowledge base 30. The computing device 11 of the information processing device 10 includes the calculation unit 111, the determination unit 112, and the control unit 113 in order to make this determination

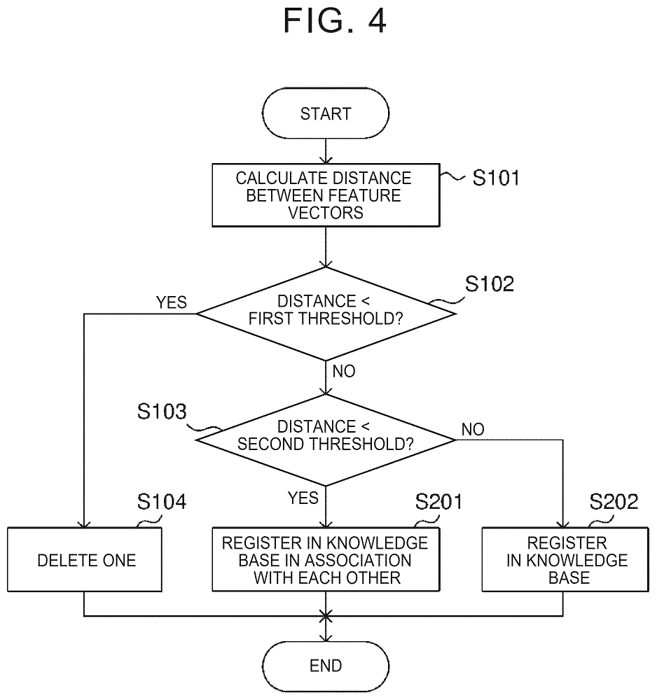

The operation of the information processing device 10 according to the second embodiment will be described with reference to the flowchart of FIG. 4. In FIG. 4, the calculation unit 111 of the information processing device 10 calculates the distance in a feature space between a third feature vector corresponding to new text data (that is, text data to be newly registered in the knowledge base 30; hereinafter also referred to as “third text data”) and a fourth feature vector corresponding to fourth text data already registered in the knowledge base 30 (S101).

The determination unit 112 of the information processing device 10 determines whether the distance calculated in S101 is smaller than a first threshold (S102) When it is determined in S102 that the distance is smaller than the first threshold (S102: Yes), the control unit 113 of the information processing device 10 deletes one of the third text data and the fourth text data (S104). In other words, the control unit 113 may maintain the registration of the fourth text data without registering the third text data in the knowledge base 30 (in this case, the third text data may be deleted). Alternatively, the control unit 113 may register the third text data in the knowledge base 30 and delete the fourth text data.

For example, the control unit 113 may delete one of the third text data and the fourth text data based on either or both of update date and time and version information. In this case, the control unit 113 may delete either the third text data or the fourth text data, whichever has the older update date and time. Alternatively, the control unit 113 may delete either the third text data or the fourth text data, whichever has an older version as indicated by the version information.

When it is determined in S102 that the distance is greater than the first threshold (S102: No), the determination unit 112 determines whether the distance is smaller than a second threshold (S103). When it is determined in S103 that the distance is smaller than the second threshold (that is, first threshold<distance<second threshold) (S103: Yes), the control unit 113 registers the third text data in the knowledge base 30 in association with the fourth text data (S201).

When it is determined in S103 that the distance is greater than the second threshold (S103: No), the control unit 113 registers the third text data in the knowledge base 30 (S202).

### Technical Effects

The information processing system 1 according to the second embodiment can reduce the possibility that a plurality of pieces of text data having the same or nearly the same content may be registered, or that both pre-update and post-update versions of text data may be registered. Accordingly, the information processing system 1 can improve the search accuracy of the knowledge base 30. In addition, the storage cost associated with the knowledge base 30 can be reduced.

In the information processing system 1 according to the second embodiment, when the distance between the third feature vector and the fourth feature vector is greater than the first threshold and smaller than the second threshold, the third text data and the fourth text data are associated with each other. In a search of the knowledge base 30, the text data associated with each other may be treated as a group of text data.

### Modifications

A plurality of pieces of text data registered in the knowledge base 30 may be clustered in a feature space, based on a plurality of feature vectors corresponding to the pieces of text data. For example, in a search of the knowledge base 30, the frequency with which text data belonging to a cluster appears in the search results may be recorded for the cluster to which the retrieved text data belongs. Even when the distance between a feature vector corresponding to text data to be newly registered (corresponding to the third text data described above) and a feature vector corresponding to text data already registered in the knowledge base 30 (corresponding to the fourth text data described above) is smaller than the first threshold, the control unit 113 may register the text data to be newly registered in the knowledge base 30 when the text data to be newly registered belongs to a cluster with a relatively high frequency.

Various aspects of the disclosure derived from the embodiment and modifications described above will be described below.

An information processing system according to an aspect of the disclosure includes: a calculator configured to calculate the distance in a feature space between a first feature vector corresponding to first text data registered in a database and a second feature vector corresponding to second text data registered in the database; a determiner configured to determine whether the calculated distance is smaller than a first threshold; and a controller configured to delete one of the first text data and the second text data when the calculated distance is smaller than the first threshold. In the above embodiment, the “knowledge base 30” is an example of the “database,” the “calculation unit 111” is an example of the “calculator,” the “determination unit 112” is an example of the “determiner,” and the “control unit 113” is an example of the “controller.”

In the information processing system of the above aspect, when the calculated distance is greater than the first threshold, the determiner may determine whether the calculated distance is smaller than a second threshold that is greater than the first threshold. When the calculated distance is smaller than the second threshold, the controller may associate the first text data with the second text data.

An information processing system according to another aspect of the disclosure includes: a calculator configured to calculate the distance in a feature space between a first feature vector corresponding to first text data and a second feature vector corresponding to second text data registered in a database; a determiner configured to determine whether the calculated distance is smaller than a first threshold; and a controller configured to either (i) maintain registration of the second text data without registering the first text data in the database or (ii) register the first text data in the database and delete the second text data, when the calculated distance is smaller than the first threshold.

In the information processing system of the above aspect, when the calculated distance is greater than the first threshold, the determiner may determine whether the calculated distance is smaller than a second threshold that is greater than the first threshold. When the calculated distance is smaller than the second threshold, the controller may register the first text data in the database in association with the second text data.

The present disclosure is not limited to the embodiment described above, and may be modified as appropriate without departing from the spirit and scope of the disclosure as understood from the claims and the entire specification. An information processing system that includes such modifications is also within the technical scope of the present disclosure.

What is claimed is:

1. An information processing system comprising:
a calculator configured to calculate a distance in a feature space between a first feature vector corresponding to first text data registered in a database and a second feature vector corresponding to second text data registered in the database;
a determiner configured to determine whether the calculated distance is smaller than a first threshold; and
a controller configured to delete one of the first text data and the second text data when the calculated distance is smaller than the first threshold.

2. The information processing system according to claim 1, wherein:
when the calculated distance is greater than the first threshold, the determiner determines whether the calculated distance is smaller than a second threshold that is greater than the first threshold; and
when the calculated distance is smaller than the second threshold, the controller associates the first text data with the second text data.

3. An information processing system comprising:
a calculator configured to calculate a distance in a feature space between a first feature vector corresponding to first text data and a second feature vector corresponding to second text data registered in a database;
a determiner configured to determine whether the calculated distance is smaller than a first threshold; and
a controller configured to either (i) maintain registration of the second text data without registering the first text data in the database or (ii) register the first text data in the database and delete the second text data, when the calculated distance is smaller than the first threshold.

4. The information processing system according to claim 3, wherein:
when the calculated distance is greater than the first threshold, the determiner determines whether the calculated distance is smaller than a second threshold that is greater than the first threshold; and
when the calculated distance is smaller than the second threshold, the controller registers the first text data in the database in association with the second text data.
